(19) United States
(12) Patent Application Publication
(10) Pub. No.: US 2024/0316832 A1
(43) Pub. Date: Sep. 26, 2024

(54) Apparatus and method for heating plastics material preforms with inspection of the holding devices

(71) Applicant: KRONES AG, Neutraubling (DE)

(72) Inventor: Michael EIFLER, Bernhardswald (DE)

(21) Appl. No.: 18/611,397

(22) Filed: Mar. 20, 2024

(30) Foreign Application Priority Data
Mar. 20, 2023 (DE) 10 2023 106 894.6

(51) Int. Cl. B29C 35/02; B29C 37/00

(52) U.S. Cl. CPC B29C 35/0277; B29C 37/00; B29C 2037/80

(57) ABSTRACT

An apparatus for heating plastics material preforms includes a transport device which transports the plastics material preforms along a predefined transport path, wherein the transport device has a circulating transport device on which a plurality of holding devices for holding the plastics material preforms to be heated are arranged. The apparatus has an inspection device which is configured for inspecting holding devices not loaded with plastics material preforms.

### BACKGROUND OF THE INVENTION

The present invention relates to a heating device and in particular an oven for heating plastics material preforms. In the prior art, it is known that plastics material preforms are first heated in an oven and are subsequently expanded by means of a blow molding machine, in particular a stretch blow molding machine, to form plastics material containers, in particular plastics material bottles. Different ovens are known. For example, infrared ovens are known which have a transport device such as a conveyor chain which conveys the plastics material preforms to be heated through a heating lane. For this purpose, holding devices for holding the plastics material preforms are provided, the holding devices in turn being arranged on the conveyor chain.

In a special embodiment, heating spindles (also referred to as holding mandrels) are provided, on which the plastics material preforms hang. Such ovens have a large number of such holding devices, in particular heating spindles. For example, in such ovens, between 160 and 500 of such heating spindles can be provided, which hold the plastics material preforms during the heating process. Since the heating spindle partially rotates with the plastics material preform, the true running must be maintained as precisely as possible. However, as a result of collisions or improper conversion, these spindles can bend, which leads to an uneven movement of the plastics material preforms.

Heating spindles which no longer run exactly properly and true can result in unevenly heated plastics material preforms. Especially in the case of very light plastics material preforms, this is more pronounced, and the containers are unevenly blow-molded or even burst.

Likewise for so-called preferential heating, in the case of which the plastics material preforms are heated unevenly on their circumference, this can severely disturb the temperature profile on the plastics material preform.

The object of the present invention is therefore to enable improved transport of the plastics material preforms and a more uniform heating.

### SUMMARY OF THE INVENTION

An apparatus according to the invention for heating plastics material preforms has a transport device, which transports the plastics material preforms along a predefined transport path. The transport device has a circulating transport means, on which a plurality of holding devices for holding the plastics material preforms to be heated are arranged.

According to the invention, the apparatus has an inspection device which is suitable and intended for inspecting holding devices not loaded with plastics material preforms.

An inspection, preferably within the oven, is therefore proposed, with which inspection in particular the position and/or orientation of the holding devices is to be determined. The apparatus advantageously has at least one heating device and preferably a plurality of heating devices.

These heating devices can be, for example, heating boxes arranged along the transport path of the plastics material preforms. Particularly preferably, these heating devices are stationary. In particular, they are so-called heating boxes.

Particularly preferably, the heating devices have irradiation devices, such as halogen lamps or the like, which apply infrared radiation to the plastics material preforms.

Particularly preferably, these heating devices are arranged on one side of the transport path. Reflector devices which reflect the heating radiation are particularly preferably arranged on the opposite side. In this way, the apparatus has at least one heating lane, through which the plastics material preforms are transported.

Preferably, this at least one heating lane is designed in such a way that the plastics material preforms can be transported through said heating lane separately and preferably in a single row. The heating lane preferably has a width which is less than six times the diameter of a main body of the plastics material preforms, preferably less than five times, preferably less than four times this diameter.

The radiation which heats the plastics material preforms is preferably infrared radiation.

In a preferred embodiment, the transport means is a conveyor belt or a conveyor chain. Furthermore, shielding devices are preferably provided which bring about a heat shielding of the mouths of the plastics material preforms. For example, the individual holding devices can have such heat shielding plates.

In a preferred embodiment, the holding devices allow the plastics material preforms to be transported separately. Particularly preferably, the holding devices, in particular with the plastics material preforms arranged therein, can be rotated about their longitudinal axis. In this way, the plastics material preforms too are rotated about their longitudinal direction, in particular also while being heated. In this way, uniform heating of the plastics material preforms in the circumferential direction of the plastics material preforms is achieved.

In a preferred embodiment, the transport path of the plastics material preforms has at least one and preferably two straight portions. These straight portions are preferably connected by a deflection region, in which the direction of movement of the plastics material preforms is reversed.

Particularly preferably, the inspection device has an image-capturing device which is suitable and intended for capturing spatially resolved images of the holding devices. The inspection device is preferably suitable and intended for contactless inspection of the holding devices.

A comparing device is preferably provided which compares the captured images with reference images, in particular in order to determine whether the holding devices are arranged and/or run centrically or eccentrically.

It is possible for the image-capturing device to capture one image of the holding devices in order to determine whether there is an eccentricity. However, it would also be possible to capture two images with different rotational positions of the holding devices, for example two images in which the holding devices are rotated by 180°, in order to be able to determine said eccentricity more easily.

It is possible to refer to specific reference points of the image, for example on a hexagonal screw which can be located in the center of the holding apparatus, in order to evaluate an eccentricity.

Particularly preferably, the holding device has a circumferential flexible element, for example in the form of an o-ring.

In a preferred embodiment, the inspection device and in particular the image-capturing device is arranged below the holding devices. Particularly preferably, the image-capturing device therefore captures an image in a vertical upward direction or is oriented in said direction.

Particularly preferably, the inspection device has a distance from the holding devices which is greater than 8 cm, preferably greater than 10 cm, and particularly preferably greater than 12 cm. Particularly preferably, the inspection device has a distance from the holding devices which is less than 30 cm, preferably less than 20 cm.

In a further preferred embodiment, the inspection device is movable and/or adjustable in a longitudinal direction of the plastics material preforms. In this way, it is easier to use the same inspection device both for inspecting the holding device and (in particular in a working mode) for inspecting the plastics material preforms.

Preferably, the inspection of the holding devices takes place in a state-monitoring run and the inspection of the plastics material preforms in a production run, wherein the state-monitoring run being different from the production run. In the state-monitoring run, in comparison to the production run, for example no preforms are present in the heating device and the heating device is operated optionally with reduced transport speed.

During the production or the production run, the inspection device is accordingly preferably used for inspecting the plastics material preforms, and in the state-monitoring run the same inspection device is used for inspecting the holding devices. The inspection device can preferably be movable in the direction of the holding device. This movement of the holding device can preferably take place automatically, wherein the position can be stored in a specification.

In a further advantageous embodiment, the holding devices are holding protrusions and preferably holding mandrels which can be inserted into the mouths of the plastics material preforms in order to hold them. Particularly preferably, the holding devices have clamping means which are suitable and intended for holding the plastics material preforms on the holding devices.

The holding devices are preferably heating mandrels or gripping devices. The heating mandrels preferably can be inserted into the mouths of the plastics material preforms. In contrast, the gripping devices preferably consist of at least two gripping elements which are movable relative to one another and which grip the plastics material preform on an outer circumference, preferably above or below the support ring.

A spindle or holding device which is empty (i.e. not occupied by a plastics material preform) is preferably captured from below by means of a camera, and the contour or surface of the spindle and/or of the holding device is preferably checked—with respect to a reference position—for concentricity.

It is possible to carry this out, for example, in the production gaps or when the machine is being started up, so that the availability of the holding device is not impaired by this.

For example, existing hardware can be used as the camera, or additional hardware can be installed as the camera. It is possible, for example, to use the camera which is also used in the gate inspection, or to use the camera used for recognizing the mouth in the preferential heating (PH) process.

In addition, a camera which is directed from below at the transport means or the oven chain can also be used.

In a further preferred embodiment, the inspection device is therefore suitable and intended for detecting a concentricity of the holding devices. Particularly preferably, the inspection device is also suitable and intended for detecting a measure of the eccentricity.

The inspection device is preferably suitable for detecting a value of the holding device that is characteristic of a concentricity. Subsequently, the detected characteristic value is preferably compared with a target value, wherein a signal and/or a recommendation for action is output when the characteristic value deviates from the target value. The target value can preferably be a fixed value, but it can also be a limit range. A deviation from the target value of up to ±2 mm, preferably ±1.5 mm, and particularly preferably ±1 mm would be conceivable, for example.

It would preferably also be conceivable that, on the basis of the information obtained, maintenance intervals are readjusted (cloud; big data). The data obtained are, for example, collected and stored in a storage device. Preferably, a new maintenance interval is calculated from the data obtained, wherein the data obtained and the new maintenance interval can also be shared with other machines via the cloud. Preferably, these data can also be used to carry out a statistical evaluation (for example, in order to determine how a dispersion changes).

In a further advantageous embodiment, the inspection device is arranged in a deflection region of the transport device, in which deflection region a direction of movement of the plastics material preforms is reversed. The arrangement in this region has the advantage that the holding devices are spaced further apart from one another in this region than in the corresponding straight portions. Alternatively, it is possible to arrange the inspection device in the entry region of the apparatus, in which entry region the plastics material preforms are fed to the heating process.

It would also be possible for the inspection device, for example in the form of a camera, to be located at a position of a heating unit, for example in an unoccupied heating box position. In this embodiment, the inspection device would be arranged in the oven itself, preferably in the middle of the oven. The background is the conceivable option of placing the camera recognition for the support ring markings in a preferential heating machine between the normal heating zone and the preferential heating zone (for example, approximately halfway on the oven rear side). This camera could also be used to monitor the spindles.

In a further advantageous embodiment, the apparatus has an assignment device which assigns an image captured by an image-capturing device to exactly one specific holding device.

For example, it can be determined that a specific image is to be assigned to a 70th holding device. Therefore, the number of the recognized spindle or of the recognized holding device is ideally known to the apparatus. In this way, this number can be reported to a user. By measurement of the deflection of the holding device or the spindle, a division into more or less critical deviations of true running is preferably also conceivable. In the case of strong reflections on the metal, a coating of the grippers is conceivable, wherein, as precisely described below, the corresponding region is preferably not in contact with the plastics material preforms.

The holding devices therefore preferably have a coating for improving the capturing of images. Particularly preferably, the holding devices have a coating in a region in which they are inspected and/or observed by the image-capturing device. Particularly preferably, the holding devices have an front-face coating. This coating can be an antireflection coating, for example. Conversely, however, it could also be a highly reflective coating.

Particularly preferably, the coating is a matte coating, in particular on the underside. Particularly preferably, this coating does not come into contact with the plastics material preforms.

In a further preferred embodiment, the holding devices have a marking, in particular in a region that can be captured by the image-capturing device. A check of the concentricity can be facilitated by this marking.

The inspection device is preferably suitable and intended for carrying out the inspection in an incident-light method.

Particularly preferably, an illuminating device is provided which illuminates the holding devices, in particular for the purpose of capturing images. Preferably, the illuminating device is a flashbulb.

The present invention is further directed to a method for heating plastics material preforms, wherein a transport device transports the plastics material preforms along a predefined transport path and wherein the transport device has a circulating transport means, on which a plurality of holding devices for holding the plastics material preforms to be heated are arranged.

According to the invention, an inspection device is provided which inspects holding devices not loaded with plastics material preforms and which preferably outputs a value which is characteristic of a concentricity of the holding devices (in particular with respect to a reference position).

For example, the inspection device can capture and/or output an image of the holding devices, from which image the concentricity or the eccentricity can be derived.

This inspection preferably occurs while the plastics material preforms move with a transport speed which is reduced in comparison with a working mode. It is possible for the inspection device to capture images of the holding devices during their movement, but it would also be possible for the individual holding devices to be stopped so that an image can be captured. It would also be possible for the holding devices to be stopped and to rotate about their own axis, so that several images (in different rotational positions) are captured in order to thus be able to determine the eccentricity even better.

Particularly preferably, images of the holding devices are captured with an assignment to the respective holding device. For example, it can be assigned to a specific image that the 70th spindle or holding device was captured in the image. Preferably, this assignment and the image are stored.

The apparatus particularly preferably monitors itself. It is possible for the apparatus to permanently monitor itself. It is possible to quickly recognize bent holding devices and to also report this to a user. Because of the assignment to the number of the spindle or of the holding device, further troubleshooting is unnecessary. The holding device can subsequently be observed, aligned or replaced.

By measurement of the change, the apparatus specifies whether replacement parts have to be installed or exchanged immediately or only in the next maintenance pause. In a preferred method, existing inspection devices or cameras are used so that barely any hardware or little hardware has to be subsequently installed by the manufacturer. In this way, retrofitting is simpler.

The present invention is further directed to an apparatus for producing plastics material containers, comprising a forming device, which has a blow molding wheel with a plurality of forming stations, wherein the forming stations each having a blow mold, within which plastics material preforms are formed to plastics material containers, and having at least one treatment element for treating and in particular forming the plastics material preforms.

According to the invention, the apparatus has an inspection device which is suitable and intended for inspecting the at least one treatment element of the forming station.

It is accordingly also proposed that the apparatus for producing the plastics material containers has an inspection device as described above. Preferably, both the apparatus for heating the plastics material preforms and the apparatus for producing the plastics material containers have such an inspection device.

In a preferred embodiment, the at least one treatment element is selected from a group of treatment elements which contains a stretching rod, a blowing nozzle, a blow mold, a bottom mold, and the like.

In a further preferred embodiment, the inspection device inspects the treatment element in a state in which the blow mold is open. In particular, side parts of the blow mold are in an open state. The inspection of the at least one treatment element is accordingly preferably carried out when no plastics material preform or plastics material container is located in the blow mold.

The inspection device is preferably suitable and intended for determining a value that is characteristic of a state of the treatment element. This can be, for example, a value from which it can be derived whether the stretching rod is bent, for example.

The inspection device is preferably suitable and intended for determining a value that is characteristic of a type of the treatment element. This can be, for example, a value from which it can be derived whether the correct stretching rod has been installed.

Particularly preferably, the inspection device is suitable and intended for determining a value which is characteristic of a state of the treatment element and of a type of the treatment element.

### BRIEF DESCRIPTION OF THE DRAWINGS

Further advantages and embodiments emerge from the accompanying drawings. In the drawings:

FIG. 1 shows a schematic representation of an apparatus according to the invention;

FIG. 2 shows a representation of a holding device;

FIG. 3a shows a representation of an image of a proper holding device; and

FIG. 3b shows a representation of an image of a faulty holding device.

### DETAILED DESCRIPTION OF THE INVENTION

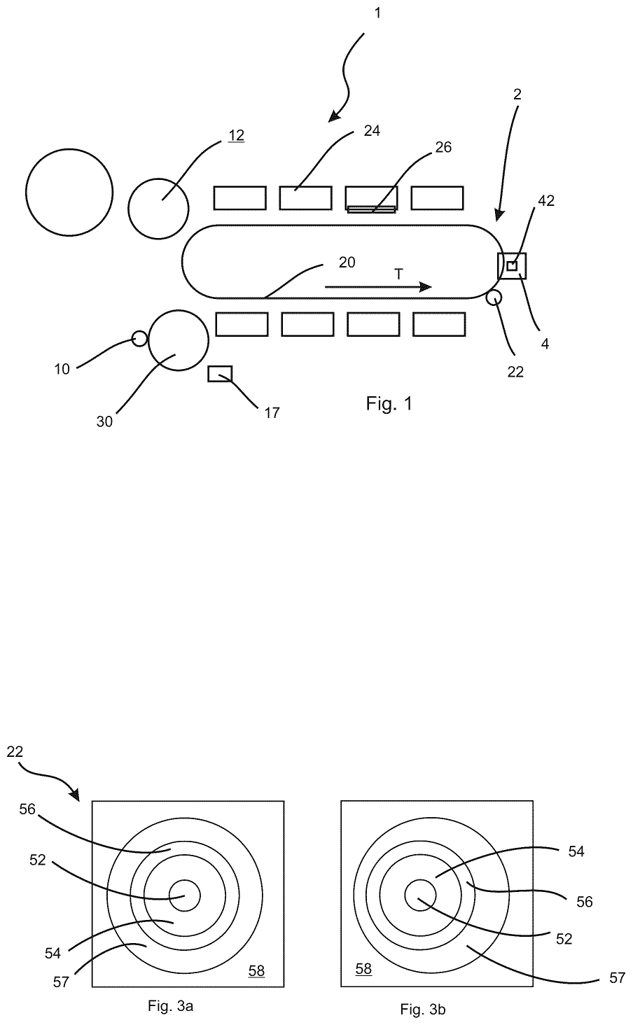

FIG. 1 shows a schematic representation of an apparatus 1 according to the invention for heating plastics material preforms 1.

This apparatus has a separating device such as a clocking star wheel 30 which separates the plastics material preforms, which are fed in a row by means of a feed device 17, and feed these separated plastics material preforms 10 to a transport device 2.

The transport device 2 transports the plastics material preforms 10 along a transport path T. This transport path T has two straight portions, which are connected by a deflection region.

The reference sign 20 refers to a circulating transport means, such as in particular a conveyor chain. A plurality of holding devices 22 for holding the plastics material preforms are arranged on this transport means.

The reference sign 24 designates a heating device such as a heating box which is stationarily arranged along the transport path T. This heating device has a plurality of heating radiators 26 which preferably extend along the transport path T; preferably a plurality of heating radiators 22 are arranged one above the other in the longitudinal direction of the plastics material preforms to be heated.

The reference sign 12 designates a further transport device, which transports the heated plastics material preforms 10 away.

The reference sign 4 designates an inspection device which is used to inspect the holding devices 22 not occupied by plastics material preforms. This can take place, for example, outside a working mode of the apparatus 1, in which working mode no plastics material preforms are arranged on the holding devices 22. This inspection device 4 preferably has an image-capturing device which captures images of the holding devices 22. This image-capturing device is in particular a camera.

The inspection device is shown here in the deflection region of the transport path T, in which deflection region the direction of movement of the plastics material preforms is reversed.

For this purpose, the image-capturing device 42 is preferably arranged below the holding devices. However, the image-capturing device could also be arranged laterally next to the transport path T, and image capturing could be enabled by deflection means such as mirrors.

Furthermore, the apparatus 1 preferably has an assignment device (not shown) which assigns to captured images the respective holding devices 22 captured in the images.

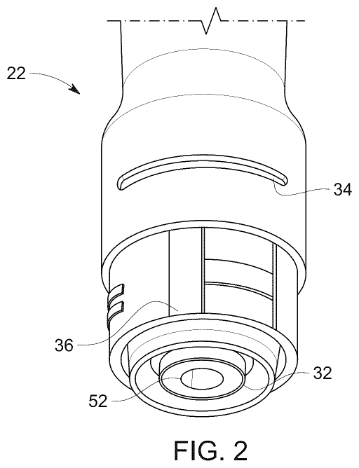

FIG. 2 shows a representation of a holding device 22. This holding device has a (lower) front face 32, which is preferably inspected by the inspection device. The reference sign 52 designates a fastening means, which preferably fastens the individual elements of the holding device to one another.

During the transport of the plastics material preforms, the lower region of the holding device 22 enters their mouths. The reference sign 36 designates clamping means, such as protrusions pushed radially outwards, which are used to hold the plastics material preforms. The reference sign 34 designates a flexible circumferential element, such as an o-ring.

FIGS. 3a and 3b show two images of a holding device. Here, the fastening means 52, which is located in the center of the holding device 22, can again be seen. The reference sign 54 designates a front face which, in particular, is used for observation or inspection. This front face can have a special coating which facilitates the observation or image evaluation.

The reference sign 56 designates an outer wall of the holding device. Preferably, this outer wall 56, the fastening means 52 and the front face 54 are concentric to one another. These elements can thus be used to detect the concentricity or to determine an eccentricity.

The reference sign 58 designates a shielding plate, which is used to prevent excessive heating of the mouths of the plastics material preforms. A circumferential gap 57 is formed between the shielding device 58 and the outer wall.

FIG. 3a shows a proper holding device. It can be seen that here the fastening means, the end face 45 and the outer wall 56 are concentric to the circumferential gap. Thus, the holding device here is aligned concentrically and thus properly.

In the case of the holding device 22 shown in FIG. 3b, there is an eccentricity. Here, the front face of the holding device 22 is slightly offset to the left relative to its target position. Thus, the holding device 22 shown in FIG. 3b is faulty.

The images captured in FIGS. 3a and 3b are preferably compared with reference images, wherein such a reference image can show a proper holding device, for example.

The apparatus 1 preferably also has an evaluation device which is suitable and intended for evaluating the captured images. The evaluation device is preferably also suitable and intended for outputting a value that is characteristic of a certain eccentricity.

This value can be assigned to a specific holding device. Depending on this value, different measures can preferably be initiated.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for heating plastics material preforms, comprising a transport device configured to transport the plastics material preforms along a predefined transport path, wherein the transport device has a circulating transport means, on which a plurality of holding devices for holding the plastics material preforms to be heated are arranged,
wherein
the apparatus has an inspection device which is configured for inspecting holding devices not loaded with plastics material preforms.

2. The apparatus according to claim 1,
wherein
the inspection device has an image-capturing device which is configured for capturing spatially resolved images of the holding devices.

3. The apparatus according to claim 2,
wherein
the image-capturing device is arranged below the holding devices.

4. The apparatus according to claim 1,
wherein
the holding devices are holding mandrels which configured for insertion into the mouths of the plastics material preforms.

5. The apparatus according to claim 1,
wherein
the inspection device is configured for detecting a value of the holding devices that is characteristic of a concentricity.

6. The apparatus according to claim 1,
wherein
the inspection device is arranged in a deflection region of the transport device, in which deflection region a direction of movement of the plastics material preforms is reversed.

7. The apparatus according to claim 1,
wherein
the apparatus has an assignment device which is configured to assign to an image captured by an inspection device exactly one specific holding device.

8. The apparatus according to claim 1,
wherein
the holding devices have a coating for improving the capturing of images.

9. A method for heating plastics material preforms, wherein a transport device transports the plastics material preforms along a predefined transport path and wherein the transport device has a circulating transport device, on which a plurality of holding devices for holding the plastics material preforms to be heated are arranged,
wherein
an inspection device is provided which inspects holding devices not loaded with plastics material preforms and which outputs a value which is characteristic of a concentricity of the holding devices.

10. The method according to claim 9,
wherein
the inspection occurs while the plastics material preforms move with a transport speed which is reduced in comparison with a working mode.

11. An apparatus for producing plastics material containers, comprising a forming device, which has a blow molding wheel with a plurality of forming stations, wherein the forming stations each having a blow mold, within which plastics material preforms are formed to plastics material containers, and having at least one treatment element for treatment,
wherein
the apparatus has an inspection device which is configured for inspecting the at least one treatment element of the forming station.

12. The apparatus according to claim 11,
wherein
the at least one treatment element is selected from a group of treatment elements which contains a stretching rod, a blowing nozzle, a blow mold, and a bottom mold.

13. The apparatus according to claim 11,
wherein
the inspection device is configured to inspect the treatment element in a state in which the blow mold is open.

14. The apparatus according to claim 11,
wherein
the inspection device is configured for determining a value that is characteristic of a state of the treatment element.

15. The apparatus according to claim 11,
wherein
the inspection device is configured for determining a value that is characteristic of a type of the treatment element.
